(19) United States
(12) Patent Application Publication
(10) Pub. No.: US 2012/0021717 A1
(43) Pub. Date: Jan. 26, 2012

(54) Speed-Disabled Mobile Phone And Method

(76) Inventor: David A. Schmidt, Bay City, MI (US)

(21) Appl. No.: 12/843,010

(22) Filed: Jul. 24, 2010

(51) Int. Cl. H04M 11/04; H04M 3/00

(52) U.S. Cl. 455/404.2; 455/418

(57) ABSTRACT

An apparatus and method for safely using a speed-sensing mobile phone with a speed-disabled state, in order to prevent phone communications from distracting a driver in a vehicle yet still allowing emergency use. In a first form, the phone includes a traffic delay timer communicating with the speed sensor, and the phone is latched or held in the speed-disabled state for a preprogrammed period of time even after the vehicle/phone speed drops to zero. In a further form, the phone includes a one-touch emergency override switch that makes an emergency phone call to a preprogrammed number, even when the phone is speed-disabled and without altering the speed-disabled state of the phone.

### RELATED APPLICATIONS/PRIORITY BENEFIT CLAIM

N/A

### FIELD

The subject matter of the present application is in the field of mobile phone disabling devices and methods.

### BACKGROUND

There are many safety concerns associated with using a mobile phone (“cell phone”) while driving. Research shows that people using mobile phones while driving have a greater difficulty maintaining a fixed speed, keeping the car in a lane, and reacting to other driving conditions. Because of these dangers, I have invented an improvement in mobile phones of the type that can be speed-disabled when the phone is moving faster than a preset speed, which almost always means that it is moving in a vehicle.

Apparatus and methods for limiting or disabling portable communication devices such as mobile phones are known. It is also known to relate the disabling function to the sensed motion of a vehicle that the phone user is driving, using various direct and indirect methods for determining the speed of the phone as the vehicle moves.

U.S. Pat. No. 6,421,538 to Byrne discloses a cordless phone with cellular capability, and circuitry for sensing when the phone is moving faster than walking speed in order to switch from cordless to cellular mode.

U.S. Pat. No. 7,608,050 to Shugg discloses a portable phone with a built-in pedometer and a motion sensor to disable the pedometer function when the phone is moving faster than walking pace, for example in a vehicle. This prevents the pedometer from counting false steps.

U.S. Published Application No. 2004/0198306 to Singh et al discloses the disabling of a cell phone in response to the vehicle ignition and/or when the vehicle is moving above a certain speed. Singh et al also discloses the possibility of an emergency switch to allow the dialing of a set of emergency numbers, overriding a disabled state of the phone to allow the phone to operate normally.

U.S. Pat. No. 7,505,784 to Barbera discloses a method for blocking a cell phone moving faster than walking speed, with a partial re-enablement if a hands-free mode is entered (this presumes that hands-free mode is safer when moving in a vehicle). The speed of the phone is determined with a GPS speed detector. “Consumer input” at the time of purchase allows an initial user or manufacturer or parent to selectively enable speed detection and the blocking function for certain other users, for example children of driving age, using a code known only to the person with authority to selectively enable the blocking function.

U.S. Pat. No. 6,353,778 to Brown discloses a cell phone capable of being limited or turned off (no calls permitted) in response to an infrared signal generated in the vehicle when the vehicle is moving. An override function allows a stored emergency telephone number to be called even when the phone is turned off. A delay can be programmed between a warning that the phone will be turned off and the phone's being turned off.

### BRIEF SUMMARY

I have invented an apparatus and method for conveniently and safely operating a speed-disabled cell phone. In a first form, the speed-disabled cell phone includes a traffic delay timer that maintains the speed-disabled status of the phone for a period of time corresponding to a likely traffic delay. This prevents the phone from being re-enabled when it is likely that the user is about to start driving again after a temporary stop. Traffic delays are defined as brief, temporary stops or pauses in driving, during which the following generally occur: the vehicle speed drops to zero, the driver remains in the car, the engine remains on, and the driver intends to resume driving as soon as some external short-lived cause for the delay is removed. External causes for a traffic delay include, without limitation, such temporary events as stops at traffic lights; stops at railroad crossings and pedestrian crossings; emergency braking to a stop to avoid people or animals or other vehicles; stops at tollbooths or parking garage cashiers; stops at drive-through windows or ATM machines; and slow moving or stop and go traffic.

In a further form, the traffic delay timer can be programmed or adjusted by the user, corresponding to the typical traffic delay encountered. In yet a further form, the traffic delay timer can be enabled, disabled, and/or adjusted only by an authorized user with a code or password, for example by a parent enabling or adjusting the delay timer for a child of driving age.

In another aspect of the invention, the mobile phone is provided with an emergency override switch that enables one-touch, sight-free dialing of a programmed emergency telephone number, for example 911, even when the phone is disabled. Pressing the override switch immediately and automatically calls the programmed number, regardless of the condition of the phone (on, off, speed-disabled, traffic delay enabled, etc.) without the user having to look at the phone or dial a number. “One-touch” should be considered to include simple mechanical activations that might require two or more motions or touches of a single emergency-call actuator, or sequential or simultaneous activation of two or more actuators, or the unlocking of a protective mechanism prior to the actual calling touch, but which do not require dialing the actual number and which are dedicated to the emergency-call use.

In a preferred form, the override switch is only capable of enabling the phone for calling the programmed emergency number, and does not otherwise change the general disabled state of the phone. In a further form, the programmed emergency number cannot be changed, except by an authorized user with a code or password. In a further form, the override switch first calls the programmed emergency number, and if no connection is made, the phone is enabled for general use.

In a further form, the override switch is protected with a mechanical feature that prevents accidental operation, such as a slide cover over the switch, a turn switch, a two-button switch, or a deeply recessed switch.

Also included in my invention are the methods of modifying the disabled state of a speed-disabled phone with my traffic delay and one-touch emergency override features.

These and other features and advantages of my invention will become apparent from further reading of the specification, in light of the accompanying drawings.

### BRIEF DESCRIPTION OF THE DRAWINGS

FIG. 1 is a plan view of an example mobile phone, with schematically illustrated circuitry according to the invention.

FIG. 2 is a schematic illustration of the traffic delay disabling method according to the invention.

FIG. 3A is a plan view of the phone of FIG. 1, including a covered override switch for enabling emergency calls.

FIG. 3B shows the phone of FIG. 3 with a protective cover moved to allow use of the override switch.

FIG. 3C shows the phone of FIG. 3 with a two-button switch, to avoid accidental operation.

FIG. 3D shows the phone of FIG. 3 with a recessed turn switch, to avoid accidental operation.

FIG. 3E shows the phone of FIG. 3 with a deeply recessed switch to avoid accidental operation.

FIG. 4 is a schematic illustration of the emergency override method according to the invention.

### DETAILED DESCRIPTION

Referring first to FIG. 1, a mobile phone of the type used for communications such as calling, texting, email, internet access, and similar functions is shown in exemplary form at 10, in order to teach how to make and use the claimed invention. I believe that virtually all makes, models, and styles of mobile phone can be manufactured or modified to operate according to my invention, and that such manufacture and modification is well within ordinary skill in the art given the following disclosure.

Phone 10 may have typical external features and controls, for example an alphanumeric keypad 12, display screen 14, microphone/speaker 16, charging port 18, USB or similar interface port 20, and others known to those skilled in the art. The internal components of phone 10, however, include a speed sensor 30, a call controller 32, and a traffic delay timer 34.

Speed sensor 30 may be a GPS speed sensor, an accelerometer, a wireless receiver with a switch tripped by a signal from an onboard vehicle speed measuring device, or any other device or combination of devices, circuits, boards, chips, hardware, software, and/or firmware, without limitation, capable of determining the speed at which the mobile phone 10 is traveling, especially while phone 10 is in a vehicle.

Speed sensor 30 communicates with call controller 32 via connection 31, which may be a wire connection, circuit board path, or any other electrical and/or data connection depending on the nature of the speed sensor 30 and the call controller 32 and the type of signal needed for the disabling response.

Call controller 32 is capable of disabling phone 10 either partially or (preferably) fully, for example by simply shutting the phone off by disconnecting battery power. Other possibilities include, but are not limited to, blocking some or all types of incoming and/or outgoing communications such as calls, texts, and/or emails; disabling keypad function; or, disabling microphones, speakers, and/or display screens. Call controller 32 may be any device or combination of devices, circuits, boards, chips, hardware, software, and/or firmware, without limitation, capable of disabling phone 10 in the above manner, the goal being to prevent the user from engaging in distracting communications with phone 10 while driving.

Traffic delay timer 34 communicates with speed sensor 30 and call controller 32 via connection(s) 33 and 35. Traffic delay timer 34 responds to the condition where the velocity of the speed-disabled phone as measured by the speed sensor drops to zero by keeping the phone 10 disabled, for example by signaling call controller 32 via connection 35 to maintain the disabled condition for a predetermined time delay. As mentioned previously, this time delay may be varied by an authorized user to correspond to the types of traffic delay most often encountered or expected in the driving range of the phone's user.

For example, in a city environment with traffic lights, drive-through services, traffic jams, and similar longer delays, the authorized user might program the delay for two-minutes' time. Where the authorized user is a parent wishing to curtail mobile phone use by a child of driving age, the delay might be programmed for a longer period of time to ensure that the disabled state is maintained even after lengthy delays. In a rural setting, where traffic delays might be shorter-lived, for example braking to let an animal cross the road or making stop-sign stops with little or no other traffic, the time delay might be programmed for a shorter time such as thirty seconds.

Programming the traffic delay timer 34 may be accomplished via keypad 12, or by connecting phone 10 to a computer or other data input device wirelessly or via interface port 20. These are merely examples, and other means and methods of programming timer 34 may be known to those skilled in the art, and thus possible.

Although speed sensor 30, call controller 32, and traffic delay timer 34 are illustrated as separate components in the example of FIG. 1, it should be understood that their physical structure and/or functionality may be incorporated into a single device, component, controller, etc.

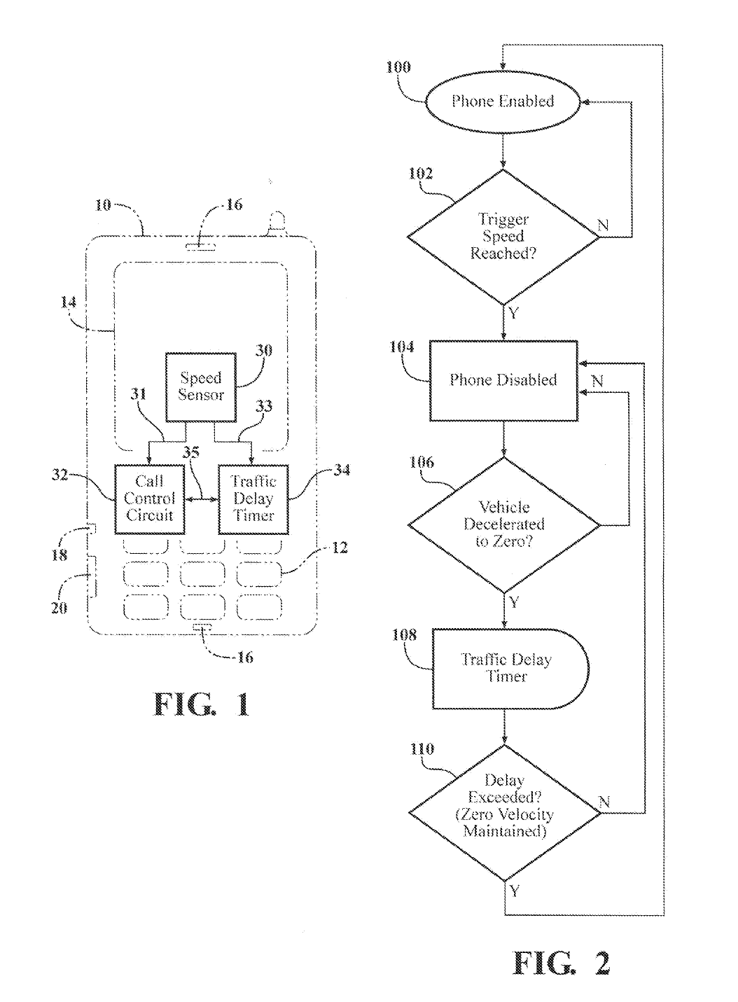

Referring now to FIG. 2, a method for maintaining phone 10 in a disabled state is illustrated in a schematic flowchart form. Phone 10 is enabled at step 100, for example when just turned on or because it has been in normal, non-driving use for a period of time. When the traffic delay trigger speed is determined to have been reached at step 102, for example when the speed sensor (FIG. 1) determines that the phone is traveling faster than 20 mph (32 kph), the phone is disabled at step 104. If the disabled phone subsequently stops moving, and the phone/vehicle speed decelerates to zero as measured by the speed sensor at step 106, then the traffic delay timer is activated at step 108.

At step 110, the input from the speed sensor is continually or periodically sampled by the call controller and/or the traffic delay timer. If the traffic delay (for example, two minutes) is exceeded and the phone remains at zero velocity, then phone 10 is or may be re-enabled, either automatically as determined by the call control circuit, or manually, for example by the user pressing a power button or key on the keypad 12. If the traffic delay is exceeded and the phone is again moving at a disabling speed when this occurs, then the phone continues to be held in the disabled state at step 104.

It may be desirable to re-set the post-delay disabling speed at a lower value than the initial disabling speed as first determined at 104. For example, stop-and-go traffic jam movement may not result in the vehicle/phone from reaching the initial disabling speed of 20 mph (32 kph) after the traffic delay time has expired, yet may still require concentration by the driver. In such case, a post-traffic-delay reset to a lower disabling speed threshold of 1 mph and up might prevent the driver from being tempted to use a re-enabled phone.

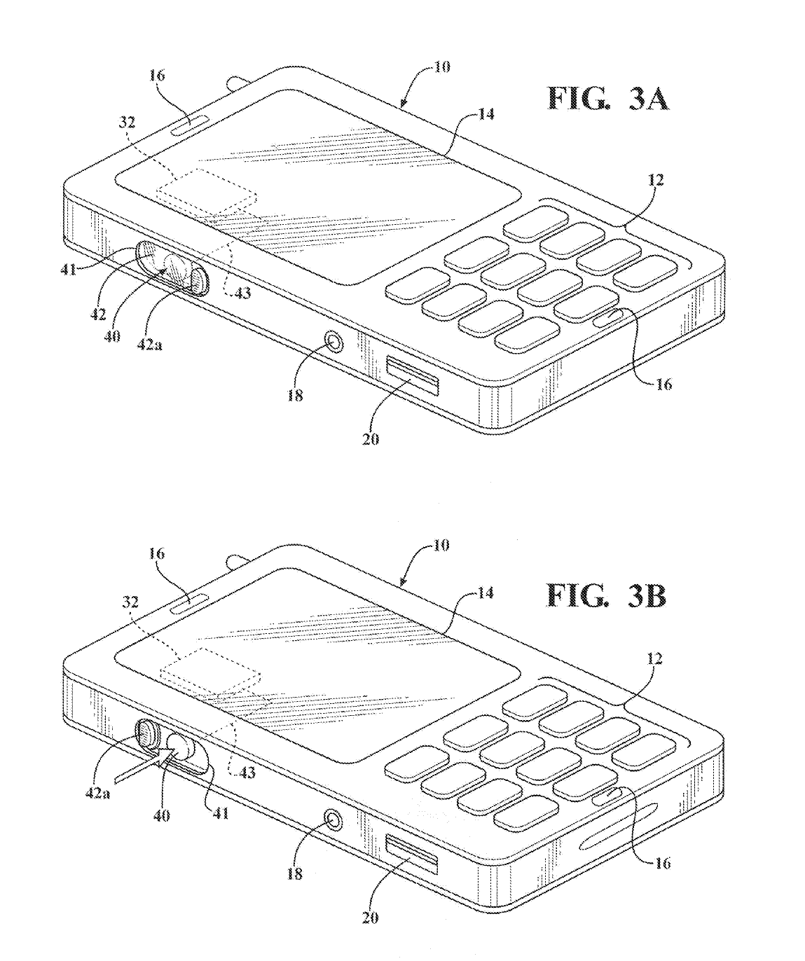

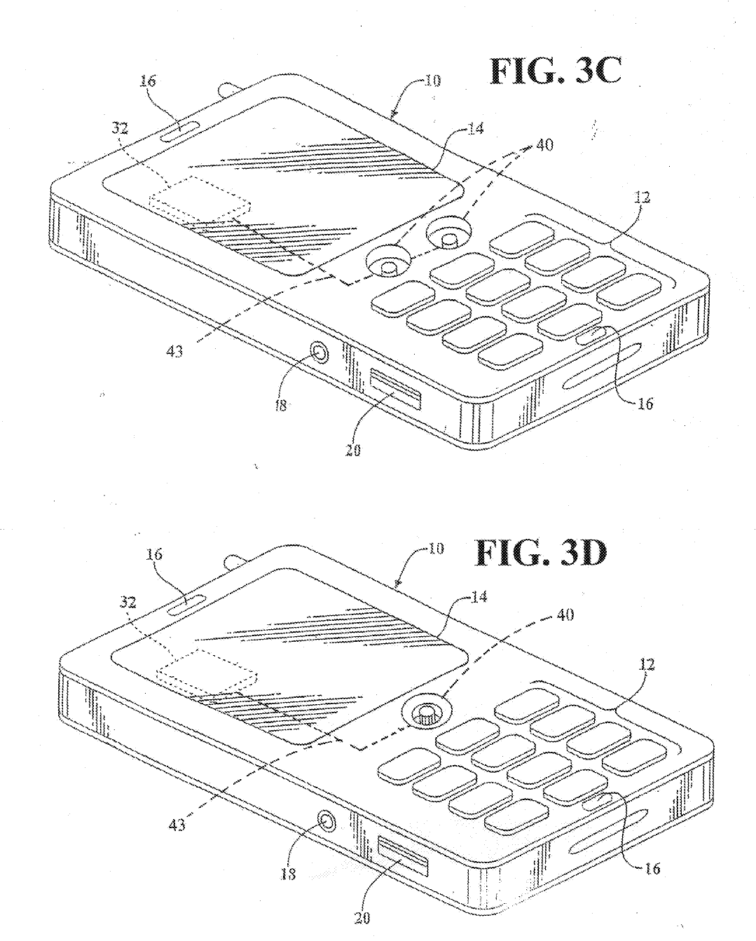

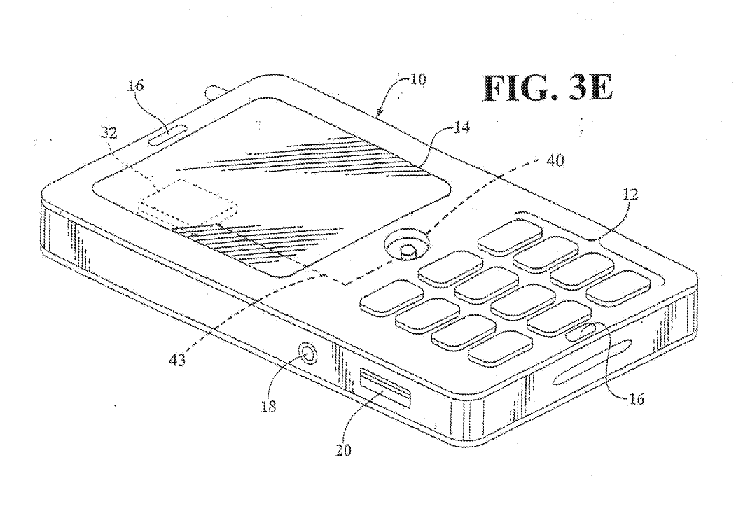

Referring next to FIGS. 3A and 3B, phone 10 has been modified to allow the user to place a call for emergency assistance regardless of the state of phone 10. In particular, where the phone is disabled because it is moving at or above the disabling speed threshold, or when the phone is subsequently latched in the previously-disabled state during a traffic delay, or even when the phone is simply turned off, a one-touch emergency override switch 40 is provided on phone 10 in a convenient location. Emergency override switch 40 is connected to call controller 32 via connection 43 to enable phone 10 just sufficiently to call a single preprogrammed emergency number or set of numbers (for example, 911 and/or one or more local fire and police agencies), with a single touch of switch 40 and without further input from the user. The user need not recall or enter numbers via keypad 12, or select from a number of choices: pressing switch 40 ensures that the call or calls is/are made.

Additionally, if phone 10 is in a speed or traffic-delay related disabled state at the time switch 40 is activated, the disabled state preferably remains unaffected by the emergency call—the phone remains disabled for other uses.

To prevent accidental activation of switch 40, the switch may be protected with a feature such as a recessed activation surface, a multi-step activating movement, or a mechanical lock or protector that must first be unlocked or removed to allow access to switch 40. For example, in the illustrated embodiment of FIGS. 3A and 3B, switch 40 is set in a recessed slot 41 in the side of the phone 10, and is further protected with a slide cover 42. When an emergency override call is desired, cover 42 must first be moved out of the way, for example by sliding it leftward with a finger using knob portion 42a, before button 40 can be pressed.

It will be understood that while a recessed, slide cover protected emergency override switch 40 is currently the preferred example, other types of switches and switch-protecting features may be employed including but not limited to switch 40 in FIGS. 3C, 3D, and 3E. Other options will be apparent to those skilled in the art.

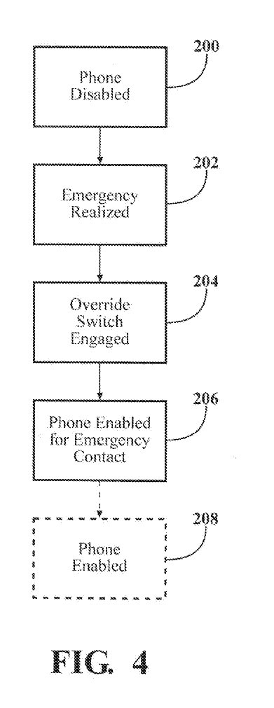

Referring next to FIG. 4, a method for making an emergency override call with phone 10 as modified in the manner of FIG. 3A is shown in schematic flowchart form. At 200 the phone is in a disabled state, for example speed-disabled, traffic delay latched, or simply turned off. At 202 the phone's user realizes an emergency, and desires to make an emergency call. At 204 the override switch is engaged, and at 206 the phone is enabled enough to make an emergency call (allowing two-way communication between any responder and the phone user) but to otherwise leave phone 10 in the disabled state. At 208, the phone may optionally be enabled to a greater degree, for example allowing follow-up calls to relatives or friends after the initial emergency call is made at 206; misuse of such greater enablement via the emergency override switch should be discouraged by the fact that an emergency service, often a governmental agency, will first be alerted to an emergency and likely send a responder unit, and would not look kindly on a false call made merely to circumvent the speed-disabled state of the phone.

It should be understood that emergency override switch 40 and call controller 32 may be programmed to place a one-touch emergency call even when the phone is enabled.

It will finally be understood that the disclosed embodiments are representative of presently preferred forms of the invention, but are intended to be explanatory rather than limiting of the scope of the invention as defined by the claims below. Reasonable variations and modifications of the invention as disclosed in the foregoing written specification and drawings are possible without departing from the scope of the invention as defined in the claims below. It should further be understood that the use of the term “invention” in this written specification is not to be construed as a limiting term as to number of inventions or discoveries or the scope of any invention or discovery, but as a descriptive term which has been used conveniently to describe advances in science and the useful arts. The scope of the invention is accordingly defined by the following claims.

What is claimed:

1. In a mobile phone including a speed sensor and a speed-disabled state, an apparatus for maintaining the mobile phone in the speed-disabled state comprising: a traffic delay timer in the mobile phone, the traffic delay timer communicating with the speed sensor to hold the phone in the speed-disabled state for a traffic delay period if the speed sensor senses that the mobile phone has returned to zero velocity while in the speed-disabled state.

2. The apparatus of claim 1, wherein the traffic delay period is programmable.

3. The apparatus of claim 2, wherein the traffic delay period is programmable only by entry of a password or code into the mobile phone.

4. The apparatus of claim 1, further comprising an emergency override switch on the mobile phone, the emergency override switch communicating with a call controller in the phone to make an emergency phone call to a preprogrammed number or set of numbers when the phone is in the speed-disabled state without altering the speed-disabled state.

5. The apparatus of claim 4, wherein the emergency override switch comprises a mechanical feature preventing accidental operation of the switch.

6. In a mobile phone including a speed sensor and a speed-disabled state, a method for maintaining the mobile phone in the speed-disabled state comprising: maintaining the phone in the speed-disabled state for a traffic delay period if the speed sensor senses that the mobile phone has returned to zero velocity while in the speed-disabled state.

7. The method of claim 7, wherein a value of a trigger speed for the speed-disabled state is lowered after the traffic delay period.

8. The method of claim 6, further comprising partially overriding the speed-disabled state by using a one-touch switch on the phone to make an emergency phone call to a preprogrammed number or set of numbers when the phone is in the speed-disabled state without altering the speed-disabled state.
